(19) United States
(12) Patent Application Publication
(10) Pub. No.: US 2003/0139293 A1
(43) Pub. Date: Jul. 24, 2003

(54) Heat sensitive recording material

(76) Inventors: James Philip Taylor, Cheshire (GB); Robert Montgomery O'Neil, Manchester (GB); Kenneth Alfred Boardman, Stockport (GB)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/221,468

(22) PCT Filed: Mar. 20, 2001
(86) PCT No.: PCT/EP01/03166

(30) Foreign Application Priority Data
Mar. 27, 2000 (GB) 007313.0
May 8, 2000 (GB) 0010993.4

(51) Int. Cl. B41M 5/30

(52) U.S. Cl. 503/216

(57) ABSTRACT

A heat sensitive recording material comprising a recording layer formed on a substrate and containing at least one colourless or light-coloured colour former and at least one colour developer, the material being characterised in that the recording material gives a blue image, and the colour developer being at least one compound represented by the formula (1) wherein R₁ is unsubstituted or substituted phenyl, naphthyl or C₁-C₂₀alkyl, X is a group of the formula (a), (b), or (c), A is unsubstituted or substituted phenylene, naphthylene or C₁-C₁₂alkylene, or is an unsubstituted or substituted heterocyclic group, B is a linking group of formula: —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O—PO—(OR₂)₂, and R₂ is unsubstituted or substituted or aryl benzyl or C₁-C₂₀alkyl, with the proviso, that, it B is not a linking group of formula —O—SO₂—, R₂ is unsubstituted or substituted phenyl, napthtyl or C₁-C₈alkyl.

This invention relates to a heat-sensitive recording material, typically in the form of sheets coated with chromogenic material (colour formers) and colour developer materials. In particular, the present invention relates to a heat- sensitive recording material with excellent thermosensitivity capable of producing a blue image that is substantially resistant to fade.

Heat-sensitive recording materials are produced by applying to a support a colourless or light-coloured chromogenic substance and a developer which reacts with the chromogenic substance upon heating to produce an image. Examples of such supports include paper, synthetic paper, plastic film or sheet. When a heating element such as a thermal print head is brought into contact with the recording material, reaction occurs between the colour former and colour developer to produce an image, thereby forming a record. These recording materials are widely used in facsimiles, ticket machines, label printers and instrument recorders etc.

A disadvantage of heat sensitive recording materials is the stability of the image, particularly towards light over a prolonged period of time. In addition, the stability of the image is lowered when it is stored under severe conditions, for example at elevated temperatures and/or humidity, or when the recording material is brought into contact with water, oils or plasticisers. These disadvantages are particularly acute in heat-sensitive recording materials that produce a blue image.

In some cases where a stable image can be obtained, this can only be achieved with a reduction in the thermal sensitivity of the recording material. In these cases, undesirably high amounts of energy must be applied by the thermal print head to produce an image of acceptable intensity.

The colour forming compounds producing blue images are, for example, triphenylmethanes, fluorans, benzoxazines, spiropyrans or preferably phthalides.

Most preferred is 3,3-bis (p-dimethylaminophenyl)-6-dimethylaminophthalide [crystal violet lactone (CVL)] as the chromogenic material. The main attractions of this colour former lie in its high intensity initial image and its relatively low cost. However, its poor image stability precludes its use in certain recording material applications where a stable image is essential or desirable. Therefore there has been a strong demand for improvement in the image stability of such heat-sensitive recording materials.

Among the colour developers used in the Art, some are known to provide improved image stabilising properties. For example, 2,4′-bis phenol sulphone; 4-hydroxy-4′-isopropoxydiphenylsulphone as disclosed in GB 2,142,630 and bis (3-allyl-4-hydroxyphenyl) sulphone as disclosed in GB 2,154,236. However, despite the use of such products, the stabilities of the blue images formed have been unsatisfactory and unable to meet the performance requirements of heat-sensitive recording materials.

Surprisingly, it has now been found that these problems are overcome by the heat sensitive recording material of the present invention, which comprises a support and a heat-sensitive coloured image-forming layer formed on the surface of the support and comprising substantially a blue colour former, a specific colour developer which reacts with the colour former upon heating to thereby develop a colour, a binder and optionally a sensitiser and/or stabiliser.

The present invention therefore provides a heat sensitive recording material comprising a recording layer formed on a substrate and containing at least one colourless or light-coloured colour former and at least one colour developer, the material being characterised in that the recording material gives a blue image, and the colour developer being at least one compound represented by the formula (1)

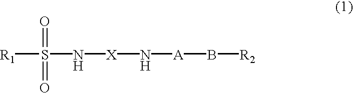

wherein

R₁ is unsubstituted or substituted phenyl, naphthyl or C₁-C₂₀alkyl,

X is a group of the formula

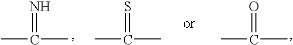

A is unsubstituted or substituted phenylene, naphthylene or C₁-C₁₂alkylene, or is an unsubstituted or substituted heterocyclic group,

B is a linking group of formula —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O—PO—(OR₂)₂, and

R₂ is unsubstituted or substituted aryl or benzyl or C₁-C₂₀alkyl, with the proviso, that, if B is not a linking group of formula —O—SO₂—, R₂ is unsubstituted or substituted phenyl, naphthyl or C₁-C₈ alkyl.

R₁ as phenyl or naphthyl can be unsubstituted or substituted by, for example, C₁-C₈alkyl, C₁-C₈alkoxy or halogen. Preferred substituents are C₁-C₄alkyl, especially methyl or ethyl, C₁-C₄alkoxy, especially methoxy or ethoxy, or halogen, especially chlorine. R₁ as naphthyl is preferably unsubstituted. R₁ as phenyl is preferably substituted, especially by one of the above alkyl substituents.

R₁ as C₁-C₂₀alkyl can be unsubstituted or substituted by, for example C₁-C₈alkoxy or halogen. Preferred substituents are C₁-C₄alkoxy, especially methoxy or ethoxy, or halogen, especially chlorine. R₁ as C₁-C₂₀alkyl is preferably unsubstituted.

Preferably, R₁ is phenyl which is unsubstituted or substituted by C₁-C₈alkyl, C₁-C₈alkoxy or halogen. Of most importance are the substituted phenyl groups. Highly preferred are phenyl groups which are substituted by C₁-C₄alkyl, preferably by methyl.

X is preferably a group of the formula

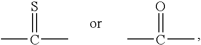

, especially a group of the formula

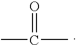

A as a phenylene or naphthylene group can be unsubstituted or substituted by, for example, C₁-C₈alkyl, halogen-substituted C₁-C₈ alkyl, C₁-C₈alkoxy-substituted C₁-C₈alkyl, C₁-C₈ alkoxy, halogen-substituted C₁-C₈alkoxy, C₁-C₈alkylsulphonyl, halogen, phenyl, phenoxy or phenoxycarbonyl. Preferred alkyl and alkoxy substituents are those containing 1 to 4 carbon atoms. Preferred substituents are C₁-C₈alkyl, halogen-substituted C₁-C₈alkyl, C₁-C₈alkyl-sulphonyl or halogen. A as a naphthylene group is preferably unsubstituted.

A as a heterocyclic group is preferably pyrimidylene which is unsubstituted or substituted by C₁-C₈alkyl, especially by C₁-C₄alkyl.

A as a C₁-C₁₂alkylene group is preferably C₁-C₈alkylene, especially C₁-C₄alkylene.

Preferred groups A are phenylene groups which are unsubstituted or substituted by C₁-C₈ alkyl, halogen-substituted C₁-C₈alkyl, C₁-C₈alkoxy-substituted C₁-C₈alkyl, C₁-C₈ alkoxy, halogen-substituted C₁-C₈alkoxy, C₁-C₈alkylsulphonyl, halogen, phenyl, phenoxy or phenoxycarbonyl, especially C₁-C₈ alkyl, halogen-substituted C₁-C₈alkyl, C₁-C₈alkylsulphonyl or halogen.

Highly preferred groups A are phenylene groups which are unsubstituted or substituted by C₁-C₄alkyl or halogen, especially unsubstituted phenylene groups.

Preferred linking groups B are those of formulae —O—SO₂—, —SO₂—O—, —SO₂—NH—, —S—SO₂—, —O—CO— and —O—CO—NH—, especially linking groups of formulae —O—SO₂—, —SO₂—O— and —SO₂—NH—. Highly preferred is the linking group B of formula —O—SO₂—.

R₂ as aryl is preferably phenyl or naphthyl which can be unsubstituted or substituted by, for example, C₁-C₈ alkyl, halogen-substituted C₁-C₈ alkyl, C₁-C₈ alkoxy-substituted C₁-C₈alkyl, C₁-C₈ alkoxy, halogen-substituted C₁-C₈ alkoxy or halogen. Preferred alkyl and alkoxy substituents are those containing 1 to 4 carbon atoms. Preferred substituents are C₁-C₄ alkyl and halogen. R₂ as naphthyl is preferably unsubstituted.

R₂ as benzyl can be substituted by the substituents given for R₂ as phenyl or naphthyl. Unsubstituted benzyl is preferred.

R₂ as C₁-C₂₀ alkyl is preferably C₁-C₈ alkyl, especially C₁-C₆ alkyl, and can be unsubstituted or substituted by, for example, C₁-C₈ alkoxy, halogen, phenyl or naphthyl. Preferred are the unsubstituted alkyl groups, especially C₁-C₄ alkyl.

Preferred groups R₂ are C₁-C₆ alkyl; halogen-substituted C₁-C₆ alkyl; phenyl-substituted C₁-C₆ alkyl; naphthyl-substituted C₁-C₆ alkyl; phenyl which is unsubstituted or substituted by C₁-C₈ alkyl, halogen-substituted C₁-C₈ alkyl, C₁-C₈ alkoxy-substituted C₁-C₈ alkyl, C₁-C₈ alkoxy, halogen-substituted C₁-C₈ alkoxy or halogen; and naphthyl.

Highly preferred groups R₂ are C₁-C₄ alkyl; halogen-substituted C₁-C₄ alkyl; phenyl which is unsubstituted or substituted by C₁-C₄ alkyl or halogen; and naphthyl, especially phenyl which is unsubstituted or substituted by C₁-C₄ alkyl.

Preferred are developers of formula (1), wherein

R₁ is phenyl which is substituted by C₁-C₄ alkyl, preferably by methyl,

X is a group of the formula

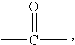

A is phenylene which is unsubstituted or substituted by C₁-C₄ alkyl or halogen, preferably unsubstituted phenylene, like 1,3-phenylene,

B is a linking group of formula —O—SO₂—, and

R₂ is phenyl or naphthyl which is unsubstituted or substituted by C₁-C₄ alkyl, especially phenyl which is substituted by C₁-C₄ alkyl.

The colour forming compounds producing blue images which are used together with the above developer are, for example, triphenylmethanes, fluorans, benzoxazines, spiropyrans or preferably phthalides.

Preferred colour formers include but are not limited to; 2-methyl-6-p-(p-dimethylaminophenyl)aminoanilinofluoran, 2-methoxy-6-p-(p-dimethylaminophenyl)aminoanilinofluoran, 2-chloro-3-methyl-6-p-(p-phenylaminophenyl)aminoanilinofluoran, 2-diethylamino-6-p-(p-dimethylaminophenyl)aminoanilinofluoran, 2-phenyl-6-methyl--6-p-(p-phenylaminophenyl)aminoanilinofluoran, 2-benzyl-6-p-(p-phenylaminophenyl)aminoanilinofluoran, 3-methyl-6-p-(p-dimethylaminophenyl)aminoanilinofluoran, 3-diethylamino-6-p-(p-diethylaminophenyl)aminoanilinofluoran, 3-diethylamino-6-p-(p-dibutylaminophenyl)aminoanilinofluoran, 2,4-dimethyl-6-[(4-dimethylamino)anilino] fluoran, 3-[(4-dimethylaminophenyl)amino]-5,7-dimethylfluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylaminophenyl)-6-dimethylaminophthalide, 3,3-bis(2,4-bis-dimethylaminophenyl)phthalide, 3,3-bis(p-dimethylaminophenyl)phthalide, 3,3-bis-[2-(p-dimethylaminophenyl)-2-(p-methoxyphenyl)ethenyl-4,5,6,7-tetrabromophthalide, 3,3-bis-[2-(p-dimethylaminophenyl)-2-(p-methoxyphenyl)ethenyl-4,5,6,7-tetrachlorophthalide, 3,3-bis[1,1-bis(4-pyrrolidinophenyl)ethylene-2-yl]-4,5,6,7-tetrabromophthalide, 3,3-bis-[1-(4-methoxyphenyl)-1-(4-pyrridinophenyl)ethylene-2-yl]-4,5,6,7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-ethyl-2-methylindole-3-yl)-3(4)-carboxyethyl-phthalide, 3-(4-diethylamino-2-methylphenyl)-3-(1-ethyl-2-methylindole-3-yl)-4-azaphthalide, 3-(4-diethylaminophenyl)-3-(1-ethyl-2-methylindole-3-yl)phthalide, 3-(2-phenyl-3-methylindolizin-3-yl)-3-(1-ethyl-2-methylindole-3-yl)phthalide, 3-(4-diethylamino-2-ethoxyphenyl)-3-(1-octyl-2-methylindole-3-yl)-4-azaphthalide, 3-(4-diethylamino-2-ethoxyphenyl)-3-(1-octyl-2-methylindole-3-yl)phthalide, 3-(4-cyclohexylethylamino-2-methoxyphenyl)-3-(1-ethyl-2-methylindole-3-yl)-4-azaphthalide, 4,4′-bisdimethylaminophenyl-(4-methylphenylsulphonyl)methane, N-benzoyl-(3,7-Bisdiethylamino)phenoxazine, N-benzoyl-(3,7-Bisdiethylamino)phenothiazine, mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 3-(4-chlorobenzoyl)-7-(dimethylamino) -4,4-bis[4-(dimethylamino)phenyl]3,4-dihydro-2(1-H)-[uinazolinone, 4-[4-(dimethylamino)phenyl]-1,4-dihydro-7-methoxy-4-(4-methoxyphenyl)-6-methyl-2H-3,1-benzoxazine-2-one and mixtures thereof.

Highly preferred compounds include but are not limited to; 3,3-bis(p-dimethylaminophenyl)-6-dimethylaminophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthalide, and mixtures thereof.

Most preferred is 3,3-bis (p-dimethylaminophenyl)-6-dimethylaminophthalide [crystal violet lactone (CVL)].

In addition, the heat sensitive recording material of the invention can contain a sensitiser. Representative examples of sensitiser are stearamide, methylol stearamide, p-benzyl-biphenyl, m-terphenyl, 2-benzyloxynaphthalene, 4-methoxybiphenyl, dibenzyl oxalate, di(4-methylbenzyl) oxalate, di(4-chlorobenzyl) oxalate, dimethyl phthalate, dibenzyl terephthalate, dibenzyl isophthalate, 1,2-diphenoxyethane, 1,2-bis(4-methylphenoxy) ethane, 1,2-bis(3-methylphenoxy) ethane, diphenyl sulphone, 4,4′-dimethylbiphenyl, phenyl-1-hydroxy-2-naphthoate, 4-methylphenyl biphenyl ether, 1,2-bis(3,4-dimethylphenyl) ethane, 2,3,5,6-4′-methyldiphenyl methane, 1,4-diethoxynaphthalene, 1,4-diacetoxybenzene, 1,4-diproprionoxybenzene, o-xylylene-bis(phenyl ether), 4-(m-methylphenoxymethyl) biphenyl, p-hydroxyacetanilide, p-hydroxybutyranilide, p-hydroxynonananilide, p-hydroxylauranilide, and p-hydroxyoctadecananilide.

In addition, the heat sensitive recording material of the invention can contain a stabiliser.

Representative stabilisers for use in heat sensitive recording materials include 2,2′-methylene-bis(4-methyl-6-tert-butylphenol), 2,2′-methylene-bis(4-ethyl-6-tert-butylphenol), 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl) butane, 1,1,3-tris(2-methyl-4-hydroxy-5-cyclohexylphenyl) butane, bis (3-tert-butyl-4-hydroxy-6-methylphenyl) sulfone, bis (3,5-dibromo-4-hydroxyphenyl) sulfone, 4,4′-sulfinyl bis (2-tert-butyl-5-methylphenol), 2,2′-methylene bis (4,6-di-tert-butylphenyl) phosphate and alkali metal, ammonium and polyvalent metal salts thereof, 4-benzyloxy-4′-(2-methylglycidyloxy) diphenyl sulfone, 4,4′-diglycidyloxydiphenyl sulfone, 1,4-diglycidyloxybenzene, 4-[α-(hydroxymethyl)benzyloxy]-4-hydroxydiphenyl sulfone, metal salts of p-nitrobenzoic acid, metal salts of phthalic acid mono benzyl ester, metal salts of cinnamic acid and mixtures thereof.

Preferred stabilisers are 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl) butane, 1,1,3-tris(2-methyl-4-hydroxy-5-cyclohexylphenyl) butane, 4-benzyloxy-4′-(2-methylglycidyloxy)diphenyl sulfone and mixtures thereof.

The heat sensitive recording material of the invention can be prepared according to conventional methods. For example, the colour forming compound, at least one developer and, if desired, at least one sensitiser are pulverised separately in water or a suitable dispersing medium, such as aqueous polyvinyl alcohol, to form an aqueous or other dispersion. If desired, a stabiliser is treated in the same manner. The fine particle dispersions thus obtained are combined and then mixed with conventional amounts of binder, filler and lubricant.

Representative binders used for the heat sensitive recording material include polyvinyl alcohol (fully and partially hydrolysed), carboxy, amide, sulfonic and butyral modified polyvinyl alcohols, derivatives of cellulose such as hydroxyethyl cellulose, methyl cellulose, ethyl cellulose, carboxymethyl cellulose and acetyl cellulose, copolymer of styrene-maleic anhydride, copolymer of styrene-butadiene, polyvinyl chloride, polyvinyl acetate, polyacrylamide, polyamide resin and mixtures thereof.

Exemplary fillers which can be used include calcium carbonate, kaolin, calcined kaolin, aluminium hydroxide, talc, titanium dioxide, zinc oxide, silica, polystyrene resin, urea-formaldehyde resin, hollow plastic pigment and mixtures thereof.

Representative lubricants for use in heat sensitive recording materials include dispersions or emulsions of stearamide, methylene bis stearamide, polyethylene, carnauba wax, paraffin wax, zinc stearate or calcium stearate and mixtures thereof.

Other additives can also be employed, if necessary. Such additives are for example fluorescent whitening agents and ultraviolet absorbers.

The coating composition so obtained can be applied to a suitable substrate such as paper, plastic sheet and resin coated paper, and used as the heat sensitive recording material. The system of the invention can be employed for other end use applications using colour forming materials, for example, a temperature indicating material.

The quantity of the coating is usually in the range of 2 to 10 g/m², most often in the range 4 to 8 g/m².

The recording material containing such a thermosensitive colouring layer can in addition contain a protective layer and, if desired, an undercoat layer. The undercoat layer may be interposed between the substrate and the thermosensitive colouring layer.

The protective layer usually comprises a water-soluble resin in order to protect the thermosensitive colouring layer. If desired, the protective layer may contain water-soluble resins in combination with water-insoluble resins.

As such resins conventional resins can be employed. Specific examples are:

polyvinyl alcohol; starch and starch derivatives; cellulose derivatives such as methoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polyesters and carboxyl modified polyvinyl alcohols.

The protective layer may also contain a water-resisting agent such as a polyamide resin, polyamide-epichlorohydrin resin, melamine resin, formaldehyde, glyoxal or chromium alum.

Furthermore, the protective layer may contain fillers, such as finely-divided inorganic powders, e.g. of calcium carbonate, silica, zinc oxide, titanium oxide, aluminium hydroxide, zinc hydroxide, barium sulphate, clay, talc, surface-treated calcium or silica, or a finely-divided organic powder of, e.g., a urea-formaldehyde resin, a styrene/methacrylic acid copolymer or polystyrene.

The undercoat layer usually contains as its main components a binder resin and a filler.

Specific examples of binder resins for use in the undercoat layer are:

polyvinyl alcohol; starch and starch derivatives; cellulose derivatives such as methoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polymers such as water-soluble polyesters and carboxyl-group-modified polyvinyl alcohols; polyvinyl acetate; polyurethanes; styrene/butadiene copolymers; polyacrylic acid; polyacrylic acid esters; vinyl chloride/vinyl acetate copolymers; polybutylmethacrylate; ethylen/vinylacetate copolymers and styrene/butadiene acrylic derivative copolymers.

Specific examples of fillers for use in the undercoat layer are:

finely-divided inorganic powders, e.g. of calcium carbonate, silica, zinc oxide, titanium oxide, aluminium hydroxide, zinc hydroxide, barium sulphate, clay, talc, surface-treated calcium, silica or calcined clay (eg Ansilex, Engelhard Corp.), and finely-divided organic powders of, e.g., urea-formaldehyde resins, styrene/methacrylic acid copolymers and polystyrene.

In addition, the undercoat layer may contain a water-resisting agent. Examples of such agents are given above.

The invention will now be illustrated by the following examples, in which all parts or percentages are by weight.

### EXAMPLE 1

This illustrates the preparation of a heat-sensitive recording material containing 3,3-bis(p-dimethylaminophenyl)-6-dimethylaminophthalide as colour former and N-(p-toluenesulphonyl)-N′-(3-p-toluenesulphonyloxyphenyl) urea as colour developer.

Dispersions A to C were prepared by grinding the compositions shown below in an attritor until average particle sizes of about 1μ were attained.

Dispersion A (Colour Former)

| | |
|---|---|
| 3,3-bis (p-dimethylaminophenyl)-6-dimethylaminophthalide | 10 parts |
| Polyvinyl alcohol (10% aqueous solution) | 35 parts |
| Water | 21.5 parts |

| Dispersion B (Colour Developer) | |
|---|---|
| N-(p-toluenesulphonyl)-N′- | 25 parts |
| (3-p-toluenesulphonyloxyphenyl) urea | |
| Polyvinyl alcohol (10% aqueous solution) | 25 parts |
| Water | 75 parts |

| Dispersion C (Sensitiser) | |
|---|---|
| di (p-methylbenzyl) oxalate | 15 parts |
| Polyvinyl alcohol (10% aqueous solution) | 15 parts |
| Water | 30 parts |

A thermal coating mixture was then prepared by combining together the following components:

| | parts |
|---|---|
| Dispersion A | 66.5 |
| Dispersion B | 125.0 |
| Dispersion C | 60.0 |
| Calcium Carbonate | 33.0 |
| Zinc stearate (33% aqueous dispersion) | 15.0 |
| Polyvinyl alcohol (20% aqueous solution) | 65.0 |
| Tinopal ® ABP-X (fluorescent whitening agent) | 1.2 |
| Water | 200.8 |

This coating mixture was applied at a coatweight of about 5.0 g/m² to a base paper weighing 50 g/m² and then dried. The resulting sheet was calendered by means of a laboratory calender to produce the recording sheet.

### COMPARATIVE EXAMPLE 1A

A heat sensitive recording material was prepared in the same manner as in Example 1 except that in preparing Dispersion B, N-(p-toluenesulphonyl)-N′-(3-p-toluenesulphonyloxy phenyl) urea was replaced by 4-hydroxy-4′-isopropoxydiphenyisulphone.

### COMPARATIVE EXAMPLE 1B

A heat sensitive recording material was prepared in the same manner as in Example 1 except that in preparing Dispersion B, N-(p-toluenesulphonyl)-N′-(3-p-toluenesulphonytoxyphenyl) urea was replaced by 2,4′-bis phenol sulphone.

### COMPARATIVE EXAMPLE 1C

A heat sensitive recording material was prepared in the same manner as in Example 1 except that in preparing Dispersion B, N-(p-toluenesuiphonyl)-N′-(3-p-toluenesulphonyloxyphenyl) urea was replaced by bis (3-allyl-4-hydroxyphenyl) sulphone.

### EXAMPLE 2

A heat sensitive recording material was prepared in the same manner as in Example 1 except that in preparing Dispersion C, di(p-methylbenzyl) oxalate was replaced by 1,2-diphenoxyethane.

### EXAMPLE 3

A heat sensitive recording material was prepared in the same manner as in Example 1 except that in preparing Dispersion C, di(p-methylbenzyl) oxalate was replaced by benzyloxynaphthalene.

### EXAMPLE 4

A heat sensitive recording material was prepared in the same manner as in Example 1 except that in preparing Dispersion C, di(p-methylbenzyl) oxalate was replaced by p-benzylbiphenyl.

### EXAMPLE 5

A heat sensitive recording material was prepared in the same manner as in Example 1 except that in preparing Dispersion C, di(p-methylbenzyl) oxalate was replaced by ethylene glycol bis (m-tolyl ether).

### EXAMPLE 6

A heat sensitive recording material was prepared in the same manner as in Example 1 except that in preparing Dispersion C, di(p-methylbenzyl) oxalate was replaced by stearamide.

### EXAMPLE 7

A heat sensitive recording material was prepared in the same manner as in Example 1 except that the use of the sensitiser Dispersion C was omitted from the formulation.

### EXAMPLE 8

Dispersion D was prepared by grinding the composition shown below in an attritor until an average particle size of about 1μ was attained.

Dispersion D (Stabiliser)

| | |
|---|---|
| 1,1,3-tris (2-methyl-4-hydroxy-5-cyclohexylphenyl)butane | 25 parts |
| Polyvinyl alcohol (10% aqueous solution) | 25 parts |
| Water | 75 parts |

A thermal coating mixture was then prepared by combining together the following components:

| | parts |
|---|---|
| Dispersion A | 66.5 |
| Dispersion B | 110.0 |
| Dispersion C | 60.0 |
| Dispersion D | 15.0 |
| Calcium Carbonate | 33.0 |
| Zinc stearate (33% aqueous dispersion) | 15.0 |
| Polyvinyl alcohol (20% aqueous solution) | 65.0 |
| Tinopal ® ABP-X (fluorescent whitening agent) | 1.2 |
| Water | 200.8 |

This coating mixture was applied at a coatweight of about 5.0 g/m² to a base paper weighing 50 g/m² and then dried. The resulting sheet was calendered by means of a laboratory calender to produce the recording sheet.

### COMPARATIVE EXAMPLE 8A

A heat sensitive recording material was prepared in the same manner as in Example 8 except that in preparing Dispersion B, N-(p-toluenesulphonyl)-N′-(3-p-toluenesulphonyloxyphenyl) urea was replaced by 4-hydroxy-4′-isopropoxydiphenylsulphone.

### COMPARATIVE EXAMPLE 8B

A heat sensitive recording material was prepared in the same manner as in Example 8 except that in preparing Dispersion B, N-(p-toluenesulphonyl)-N′-(3-p-toluenesulphonyloxyphenyl) urea was replaced by 2,4′-bis phenol sulphone.

### COMPARATIVE EXAMPLE 8C

A heat sensitive recording material was prepared in the same manner as in Example 8 except that in preparing Dispersion B, N-(p-toluenesulphonyl)-N′-(3-p-toluenesulphonyloxyphenyl) urea was replaced by bis (3-allyl-4-hydroxyphenyl) sulphone.

### EXAMPLE 9

A heat sensitive recording material was prepared in the same manner as in Example 5 except that in preparing Dispersion A, 3,3-bis (p-dimethylaminophenyl)-6-dimethylaminophthalide was replaced by a mixture of 7.5 parts 3,3-bis (p-dimethylaminophenyl)-6-dimethylaminophthalide and 2.5 parts 3-(4-diethylamino-2-ethoxyphenyl)-3-(1-octyl-2-methylindole-3-yl)-4-azaphthalide.

### EXAMPLE 10

A heat sensitive recording material was prepared in the same manner as in Example 8 except that in preparing Dispersion C, di(p-methylbenzyl) oxalate was replaced by ethylene glycol bis (m-tolyl ether) and in the preparation of Dispersion D 1,1,3-tris (2-methyl-4-hydroxy-5-cyclohexylphenyl)butane was replaced by D 1,1,3-tris (2-methyl-4-hydroxy-5-tert-butylphenyl)butane.

### EXAMPLE 11

A heat sensitive recording material was prepared in the same manner as in Example 8 except that in preparing Dispersion C, di(p-methylbenzyl) oxalate was replaced by stearamide and in the preparation of Dispersion D 1,1,3-tris (2-methyl-4-hydroxy-5-cyclohexylphenyl)butane was replaced by D 1,1,3-tris (2-methyl-4-hydroxy-5-tert-butylphenyl)butane.

### EXAMPLE 12

A heat sensitive recording material was prepared in the same manner as in Example 8 except that in preparing Dispersion C, di(p-methylbenzyl) oxalate was replaced by ethylene glycol bis (m-tolyl ether).

### EXAMPLE 13

A heat sensitive recording material was prepared in the same manner as in Example 8 except that in preparing Dispersion C, di(p-methylbenzyl) oxalate was replaced by stearamide.

Evaluation:

Initial Image Intensity and Background Colouration

The heat sensitive recording materials thus obtained were used in an Atlantek Thermal Response Tester (Model 200) for recording and then the colour densities of the recorded images and the background densities of the blank areas were measured with a Macbeth densitometer (Model 1200).

Plasticiser Resistance

The recording material, comprising of an imaged and un-imaged section, was contacted with a strip of PVC (phthalate ester plasticiser content 20-25%) under 100 g cm⁻² pressure for 24 hours/50° C. The colour densities of the imaged and un-imaged sections of the recording material were measured using a MacBeth densitometer before and after the test. The intensity of the image remaining at the end of the test was expressed as a percentage of the initial colour density.

Oil Resistance

The recording material, comprising of an imaged and un-imaged section, was coated with a thin layer of cottonseed oil using a gravure printer and stored for 24 hours/40° C. The colour densities of the imaged and un-imaged sections of the recording material were measured using a MacBeth densitometer before and after the test. The intensity of the image remaining at the end of the test was expressed as a percentage of the initial colour density.

Light Fastness

The recording material, comprising of an imaged and un-imaged section, was exposed to fluorecent tubes emitting artificial sunlight (approximately 1200 Lux) for 120 hours. The colour densities of the imaged and un-imaged sections of the recording material were measured using a MacBeth densitometer before and after the test. The intensity of the image remaining at the end of the test was expressed as a percentage of the initial colour density.

Water Fastness

The imaged recording material was immersed in de-ionised water for 3 hours at 20 C. The colour density of the imaged section of the recording material was measured using a MacBeth densitometer before and after the test. The intensity of the image remaining at the end of the test was expressed as a percentage of the initial colour density. The results of the above evaluations are illustrated in Table 1.

TABLE 1

| Recording | Initial | | | Light | |
|---|---|---|---|---|---|
| Material | Intensity/ | Plasticiser | Oil | Fastness/ | Water |
| prepared | Back- | Resistance/ | Resistance/ | Back- | Resis- |
| from | ground | Background | Background | ground | tance |
| Example 1 | 1.50 | 54% | 97% | 33% | 80% |
| | 0.05 | 0.02 | 0.03 | 0.18 | |
| Example | 1.44 | 19% | 64% | 0* | 59% |
| 1A | 0.05 | 0.02 | 0.03 | 0.18 | |
| Example | 1.51 | 7% | 71% | 0* | 73% |
| 1B | 0.05 | 0.03 | 0.03 | 0.18 | |
| Example | 1.57 | 14% | 73% | 0* | 80% |
| 1C | 0.05 | 0.03 | 0.04 | 0.18 | |
| Example 2 | 1.44 | 64% | 104% | 40% | 81% |
| | 0.04 | 0.04 | 0.04 | 0.19 | |
| Example 3 | 1.31 | 56% | 111% | 40% | 65% |
| | 0.04 | 0.04 | 0.04 | 0.21 | |
| Example 4 | 1.37 | 51% | 109% | 36% | 31% |
| | 0.04 | 0.04 | 0.04 | 0.19 | |
| Example 5 | 1.44 | 50% | 103% | 56% | 76% |
| | 0.04 | 0.04 | 0.04 | 0.17 | |
| Example 6 | 1.47 | 59% | 102% | 53% | 89% |
| | 0.04 | 0.04 | 0.04 | 0.21 | |
| Example 7 | 0.88 | 64% | 121% | 49% | 84% |
| | 0.04 | 0.04 | 0.04 | 0.20 | |
| Example 8 | 1.44 | 72% | 98% | 28% | 88% |
| | 0.02 | 0.02 | 0.02 | 0.12 | |
| Example | 1.39 | 35% | 77% | 0* | 65% |
| 8A | 0.03 | 0.02 | 0.02 | 0.17 | |
| Example | 1.47 | 5% | 64% | 0* | 77% |
| 8B | 0.02 | 0.02 | 0.03 | 0.17 | |
| Example | 1.52 | 20% | 76% | 0* | 84% |
| 8C | 0.02 | 0.02 | 0.02 | 0.18 | |
| Example 9 | 1.39 | 76% | 103% | 54% | 83% |
| | 0.02 | 0.04 | 0.05 | 0.23 | |
| Example | 1.45 | 76% | 99% | 62% | 83% |
| 10 | 0.04 | 0.02 | 0.03 | 0.15 | |
| Example | 1.45 | 65% | 98% | 58% | 95% |
| 11 | 0.04 | 0.02 | 0.03 | 0.16 | |
| Example | 1.43 | 75% | 99% | 55% | 87% |
| 12 | 0.04 | 0.02 | 0.03 | 0.15 | |
| Example | 1.45 | 67% | 99% | 52% | 95% |
| 13 | 0.04 | 0.02 | 0.03 | 0.16 | |

*The blue image had disappeared completely and a very pale yellow image remained.

The results of these evaluations clearly demonstrate the superior image stability properties of heat sensitive recording materials prepared using the compositions of this invention.

1. A heat sensitive recording material comprising a recording layer formed on a substrate and containing at least one colourless or light-coloured colour former and at least one colour developer, the material being characterised in that the recording material gives a blue image, and the colour developer being at least one compound represented by the formula (1) 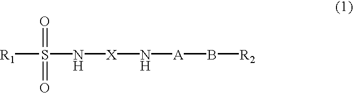
wherein
R₁ is unsubstituted or substituted phenyl, naphthyl or C₁-C₂₀alkyl,
X is a group of the formula 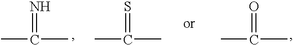
A is unsubstituted or substituted phenylene, naphthylene or C₁-C₁₂alkylene, or is an unsubstituted or substituted heterocyclic group,
B is a linking group of formula —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O—PO—(OR₂)₂, and
R₂ is unsubstituted or substituted aryl or benzyl or C₁-C₂₀alkyl, with the proviso, that, if b is not a linking group of formula —O—SO₂—, R₂ is unsubstituted or substituted phenyl, naphthyl or C₁-C₈alkyl.

2. A heat sensitive recording material acCOrding to claim 1, wherein the colour former is selected from the group consisting of 2-methyl-6-p-(p-dimethylaminophenyl)aminoanilinofluoran, 2-methoxy-6-p-(p-dimethylaminophenyl)aminoanilinofluoran, 2-chloro-3-methyl-6-p-(p-phenylaminophenyl)aminoanilinofluoran, 2-diethylamino-6-p-(p-dimethyl-aminophenyl)aminoanilinofluoran, 2-phenyl-6-methyl--6-p-(p-phenylaminophenyl)aminoanilinofluoran, 2-benzyl-6-p-(p-phenylaminophenyl)aminoanilinofluoran, 3-methyl-6-p-(p-dimethylaminophenyl)aminoanilinofluoran, 3-diethylamino-6-p-(pdiethylaminophenyl)-aminoanilinofluoran, 3-diethylamino-6-p-(p-dibutylaminophenyl)aminoanilinofluoran, 2,4-dimethyl-6-[(4-dimethylamino)anilino] fluoran, 3-[(4-dimethylaminophenyl)amino]-5,7-dimethylfluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylaminophenyl)-6-dimethylaminophthalide, 3,3-bis(2,4-bis-dimethylaminophenyl)phthalide, 3,3-bis(p-dimethylaminophenyl)phthalide, 3,3-bis-[2-(p-dimethylaminophenyl)-2-(p-methoxyphenyl)ethenyl-4,5,6,7-tetrabromophthalide, 3,3-bis-[2-(p-dimethylaminophenyl)-2-(p-methoxyphenyl)ethenyl-4,5,6,7-tetrachlorophthalide, 3,3-bis[1,1-bis(4-pyrrolidinophenyl)ethylene-2-yl]-4,5,6,7-tetrabromophthalide, 3,3-bis-[1-(4-methoxyphenyl)-1-(4-pyrridinophenyl)ethylene-2-yl]-4,5,6,7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-ethyl-2-methylindole-3-yl)-3(4)-carboxyethylphthalide, 3-(4-diethylamino-2-methylphenyl)-3-(1-ethyl-2-methylindole-3-yl)-4-azaphthalide, 3-(4-diethylaminophenyl)-3-(1-ethyl-2-methylindole-3-yl)phthalide, 3-(2-phenyl-3-methylindolizin-3-yl)-3-(1-ethyl-2-methylindole-3-yl)phthalide, 3-(4-diethylamino-2-ethoxyphenyl)-3-(1-octyl-2-methylindole-3-yl)-4-azaphthalide, 3-(4-diethylamino-2-ethoxyphenyl)-3-(1-octyl-2-methylindole-3-yl)phthalide, 3-(4-cyclohexylethylamino-2-methoxyphenyl)-3-(1-ethyl-2-methylindole-3-yl)-4-azaphthalide, 4,4′-bisdimethylaminophenyl-(4-methylphenylsulphonyl)methane, N-benzoyl-(3,7-Bisdiethylamino)phenoxazine, N-benzoyl-(3,7-Bisdiethylamino)phenothiazine, mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 3-(4-chlorobenzoyl)-7-(dimethylamino)-4,4-bis[4-(dimethylamino)phenyl]3,4-dihydro-2(1-H)[uinazolinone, 4-[4-(dimethylamino)phenyl]-1,4-dihydro-7-methoxy-4-(4-methoxyphenyl)-6-methyl-2H-3,1-benzoxazine-2-one and mixtures thereof.

3. A heat sensitive recording material according to claim 2, wherein the colour former is selected from the group consisting of 3,3-bis(p-dimethylaminophenyl)-6-dimethylaminophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthalide and mixtures thereof.

4. A heat sensitive recording material according to claim 3 wherein the colour former is 3,3-bis (p-dimethylaminophenyl)-6-dimethylaminophthalide.

5. A heat sensitive recording material according to any of claims 1-4 in which the colour developer is of formula (1), wherein R₁ is phenyl which is unsubstituted or substituted by C₁-C₈alkyl, C₁-C₈alkoxy or halogen.

6. A heat sensitive recording material according to any of claims 1-5 in which the colour developer is of formula (1), wherein X is a group of the formula

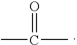

7. A heat sensitive recording material according to any of claims 1-6 in which the colour developer is of formula (1), wherein A is phenylene which is unsubstituted or substituted by C₁-C₈alkyl, halogen-substituted C₁-C₈alkyl, C₁-C₈alkoxy-substituted C₁-C₈alkyl, C₁-C₈alkoxy, halogen-substituted C₁-C₈alkoxy, C₁-C₈alkylsulphonyl, halogen, phenyl, phenoxy or phenoxycarbonyl; or is naphthylene; or C₁-C₁₂alkylene; or pyrimidylene which is unsubstituted or substituted by C₁-C₈alkyl.

8. A heat sensitive recording material according to any of claims 1-7 in which the colour developer is of formula (1), wherein B is a linking group of formula —O—SO₂—, —SO₂—O—, —SO₂—NH—, —S—SO₂—, —O—CO—, —O—, —O—CO—NH—, —SO₂—NH—CO—, —O—CO—O— or —O—PO—(OR₂)₂.

9. A heat sensitive recording material according to any of claims 1-8 in which the colour developer is of formula (1), wherein R₂ is C₁-C₆alkyl; halogen-substituted C₁-C₆alkyl; phenyl-substituted C₁-C₆alkyl; naphthyl-substituted C₁-C₆alkyl; phenyl which is unsubstituted or substituted by C₁-C₈alkyl, halogen-substituted C₁-C₈alkyl, C₁-C₈alkoxy-substituted C₁-C₈alkyl, C₁-C₈alkoxy, halogen-substituted C₁-C₈alkoxy or halogen; naphthyl and benzyl which is substituted by C₁-C₄alkyl or halogen.

10. A heat sensitive recording material according to any of claims 1-9 in which the colour developer is of formula (1), wherein R₁ is phenyl which is substituted by C₁-C₄alkyl, preferably methyl,
X is a group of the formula 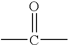
A is phenylene which is unsubstituted or substituted by C₁-C₄alkyl or halogen, preferably unsubstituted phenylene,
B is a linking group of formula —O—SO₂— or —O—, and
R₂ is phenyl or benzyl which is unsubstituted or substituted by C₁-C₄alkyl.

11. A heat sensitive recording material according to any of claims 1-10 in which the colour developer is N-(p-toluenesulphonyl)-N′-(3-p-toluenesulphonyloxyphenyl) urea.

12. A heat sensitive recording material according to any of claims 1-11, wherein the recording material contains at least one sensitiser.

13. A heat sensitive recording material according to any of claims 1-12 wherein the sensitiser is selected from the group consisting of stearamide, methylol stearamide, p-benzylbiphenyl m-terphenyl, 2-benzyloxynaphthalene, 4-methoxybiphenyl, dibenzyl oxalate, di(4-methylbenzyl) oxalate, di(4-chlorobenzyl) oxalate, dimethyl phthalate, dibenzyl terephthalate, dibenzyl isophthalate, 1,2-diphenoxyethane, 1,2-bis(4-methylphenoxy) ethane, 1,2-bis(3-methylphenoxy) ethane, diphenylsulphone, 4,4′-dimethylbiphenyl, phenyl-1-hydroxy-2-naphthoate, 4-methylphenyl biphenyl ether, 2,2-bis(3,4-dimethylphenyl) ethane, 2,3,5,6-4′-methyldiphenyl methane, 1,4-diethoxynaphthalene, 1,4-diacetoxybenzene, 1,4-diproprionoxybenene, o-xylylene-bis(phenyl ether), 4(m-methylphenoxymethyl) biphenyl, p-hydroxyacetanilide, p-hydroxybutyranilide, p-hydroxynonananilide, p-hydroxylauranilide and p-hydroxyoctadecananilide.

14. A heat sensitive recording material according to any of claims 1-13, wherein the recording material comprises at least one stabiliser.

15. A heat sensitive recording material according to any of claims 1-14, wherein the recording material comprises at least one stabiliser selected from the group consisting of 2,2′-methylene-bis(4-methyl-6-tert-butylphenol), 2,2′-methylene-bis(4-ethyl-6-tert-butylphenol), 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl) butane, 1,1,3-tris(2-methyl-4-hydroxy-5-cyclohexylphenyl) butane, bis (3-tert-butyl-4-hydroxy-6-methylphenyl) sulfone, bis (3,5-dibromo-4-hydroxyphenyl) sulfone, 4,4′-sulfinyl bis (2-tert-butyl-5-methylphenol), 2,2′-methylene bis (4,6-di-tert-butylphenyl) phosphate and alkali metal, ammonium and polyvalent metal salts thereof, 4-benzyloxy-4′-(2-methylglycidyloxy) diphenyl sulfone, 4,4′-diglycidyloxydiphenyl sulfone, 1,4-diglycidyloxybenzene, 4-[α-(hydroxymethyl)benzyloxy]-4-hydroxydiphenyl sulfone, metal salts of p-nitrobenzoic acid, metal salts of phthalic acid mono benzyl ester, metal salts of cinnamic acid and mixtures thereof.
